(19) United States
(12) Patent Application Publication
(10) Pub. No.: US 2019/0298111 A1
(43) Pub. Date: Oct. 3, 2019

(54) Shower structure with hot air function

(71) Applicants: CHIN-LUNG WU, Taichung City (TW); WEI-SHENG WU, New Taipei City (TW)

(72) Inventors: CHIN-LUNG WU, Taichung City (TW); WEI-SHENG WU, New Taipei City (TW)

(21) Appl. No.: 15/939,200

(22) Filed: Mar. 28, 2018

(51) Int. Cl. A47K 3/28; A45D 20/16

(52) U.S. Cl. CPC A47K 3/281; A45D 20/16

(57) ABSTRACT

A shower structure with a hot air function includes a fixed base with a watertight switch, a shower head, and a hot air structure. The fixed base has a water supply end and a water outlet, and an end of the shower head is coupled to the water outlet, and the hot air structure includes one or more pipe members, one or more fans, and one or more electrical heating pipes, and plural air inlet holes and an air outlet are formed at the external periphery of the pipe member, and the fan and electrical heating pipe are installed in the pipe member, and the fan and electrical heating pipe are electrically connected to the switch of the fixed base. The shower structure facilitates users to blow dry their hair directly after taking a shower.

### FIELD OF THE INVENTION

The present disclosure relates to a shower structure with a hot air function, in particular to a shower head combined with a hot-air hair dryer function.

### BACKGROUND OF THE INVENTION

To take a shower, most people hold a shower head to wash their body first, and then put some shower gel or soap onto their body for cleaning, and finally use the shower head to wash their body, and blow dry their hair after the body is wiped and dried.

However, the difference between the temperature of the shower and the ambient temperature is very large, so that the users may catch a cold easily if they are not kept warm enough or cold air blows at their head directly. Obviously, the prior art requires further improvements.

### SUMMARY OF THE INVENTION

Therefore, it is a primary objective of this disclosure to overcome the aforementioned drawbacks by providing a shower structure with a hot air function to facilitate users to blow dry their hair directly after taking a shower, so as to prevent the users from catching a cold due to a large difference between the outdoor and indoor temperatures.

Another objective of this disclosure is to provide a shower structure with a hot air function that allows users to pivot and adjust the shower structure to an appropriate angle.

To achieve the aforementioned and other objectives, this disclosure provides a shower structure with a hot air function, comprising: a fixed seat, having a water supply end and a water outlet disposed at predetermined positions of the fixed base respectively, and a watertight switch installed at a predetermined position of the fixed base; a shower head, with an end coupled to the water outlet of the fixed base; a hot air structure, comprised of one or more pipe members, one or more fans and one or more electrical heating pipes, and a plurality of air inlet holes and an air outlet formed at predetermined positions of the external periphery of the pipe member respectively, and the fan and the electrical heating pipe being installed in the pipe member, and the fan and the electrical heating pipe being electrically coupled to the switch of the fixed base.

Wherein, the shower head is a top shower head.

Wherein, the shower head is a handheld shower head.

Wherein, the air outlet of the pipe member is in the shape of a cut groove.

The shower structure further comprises an adapter elbow, and a protrusion protruded from an outer side of the fixed base for fixing the adapter elbow, and a free end of the adapter elbow is provided for fixing the pipe member, so that the hot air structure can be pivoted to an appropriate angle.

### BRIEF DESCRIPTION OF THE DRAWINGS

FIG. 1 is a perspective view of this disclosure;

FIG. 2 is an exploded view of this disclosure;

FIG. 3 is a partial cross-sectional view of this disclosure; and

FIG. 4 is a schematic view of adjusting an angle in accordance with an embodiment of this disclosure; and

FIG. 5 is a schematic view of using a hot air function in accordance with an embodiment of this disclosure.

### DESCRIPTION OF THE PREFERRED EMBODIMENTS

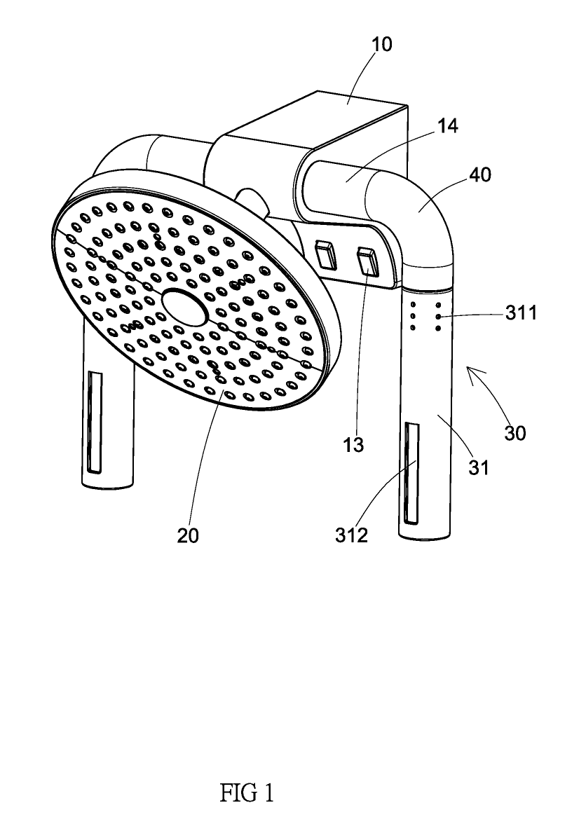

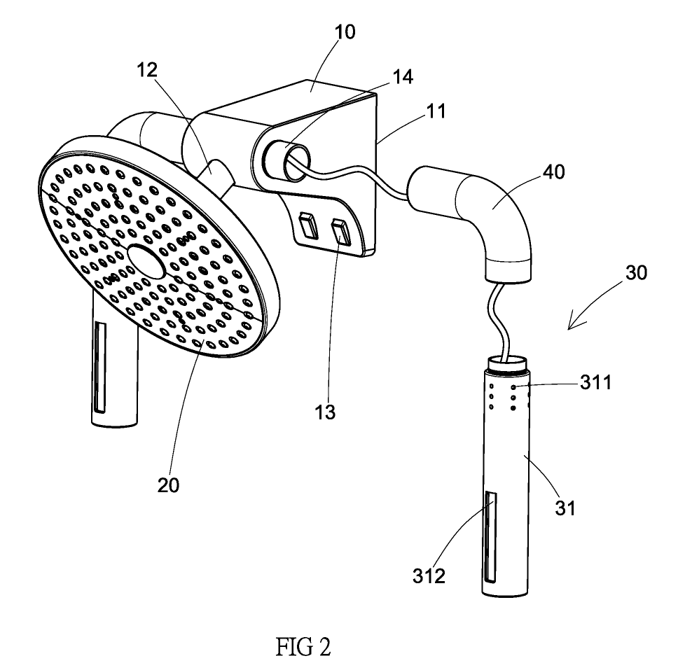

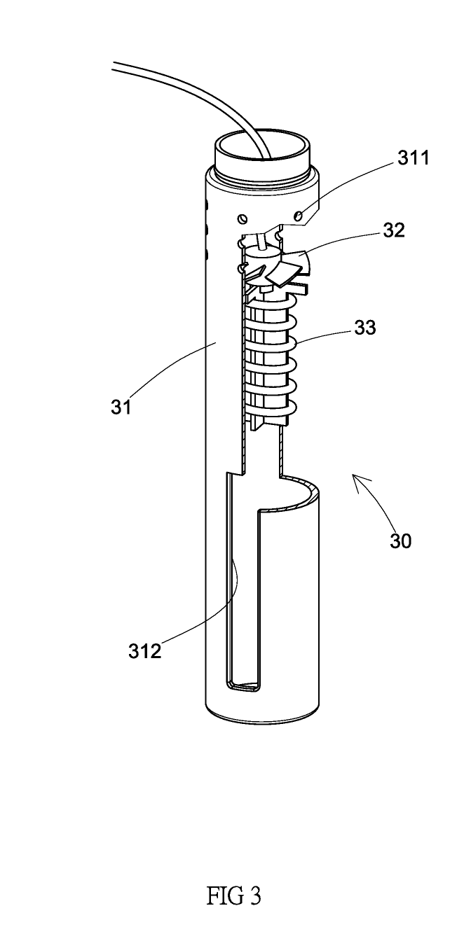

With reference to FIGS. 1 to 5 for a shower structure with a hot air function according to this disclosure, the shower structure comprises:

a fixed base 10, a water supply end 11 and a water outlet 12 disposed at predetermined positions of the fixed base 10 respectively, and a watertight switch 13 installed at a predetermined position of the fixed base 10;

a shower head 20, with an end coupled to the water outlet 12 of the fixed base 10;

a hot air structure 30, comprised of one or more pipe members 31, one or more fans 32 and one or more electrical heating pipes 33, and a plurality of air inlet holes 311 and an air outlet 312 being formed at the predetermined position of the pipe member 31 respectively, and the fan 32 and the electrical heating pipe 33 being installed in the pipe member 31, and the fan 32 and the electrical heating pipe 33 being electrically coupled to the switch 13 of the fixed base 10.

Wherein, the shower head 20 is a top shower head.

Wherein, the shower head 20 is a handheld shower head.

Wherein, the air outlet 312 of the pipe member 31 is in the shape of a cut groove.

The shower structure further comprises an adapter elbow 40, a protrusion 14 protruded from an outer side of the fixed base 10 for fixing the adapter elbow 40, and a free end of the adapter elbow 40 being provided for fixing the pipe member 31, so that the hot air structure 40 can be pivoted to an appropriate angle.

In FIGS. 1 to 5, when a user is taking a shower, the user directly, and turns on a thermostat faucet handle (not shown in the figure) to enter water from the water supply end 11 of the fixed base 10 and output the water from the water outlet 12 to the shower head 20 (wherein the shower head 20 of this embodiment is the top shower head), so as to achieve the effect of taking a shower. The whole operation is simple and convenient.

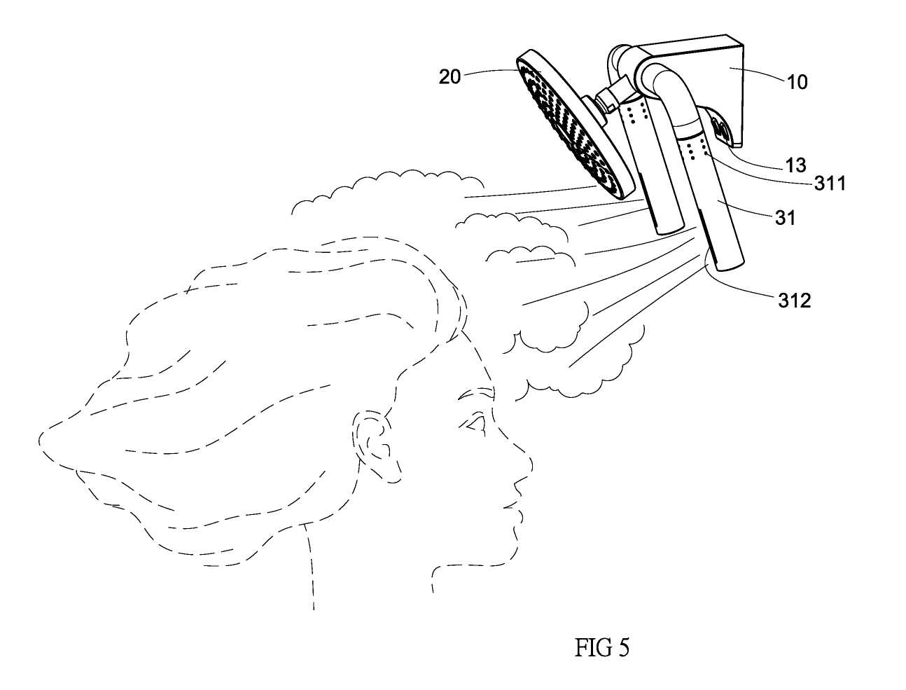

It is noteworthy that after the user finishes the shower, an external hot air structure 30 is provided, so that the user can turn on the switch 13 of the fixed base 10 to supply electric power to a fan 32 and an electrical heating pipe 33, and the air inlet holes 311 of the pipe member 31 suck in the air which is heated by the electrical heating pipe 33, so that the fan 32 can blow hot air out from the air outlet 312 of the pipe member 31 to achieve the effect of drying hair (as shown in FIG. 5). The operation is simple and convenient. This disclosure facilitates users to blow dry their air directly after taking a shower, so as to prevent them from catching a cold due to the large temperature difference between the shower temperature and the ambient temperature.

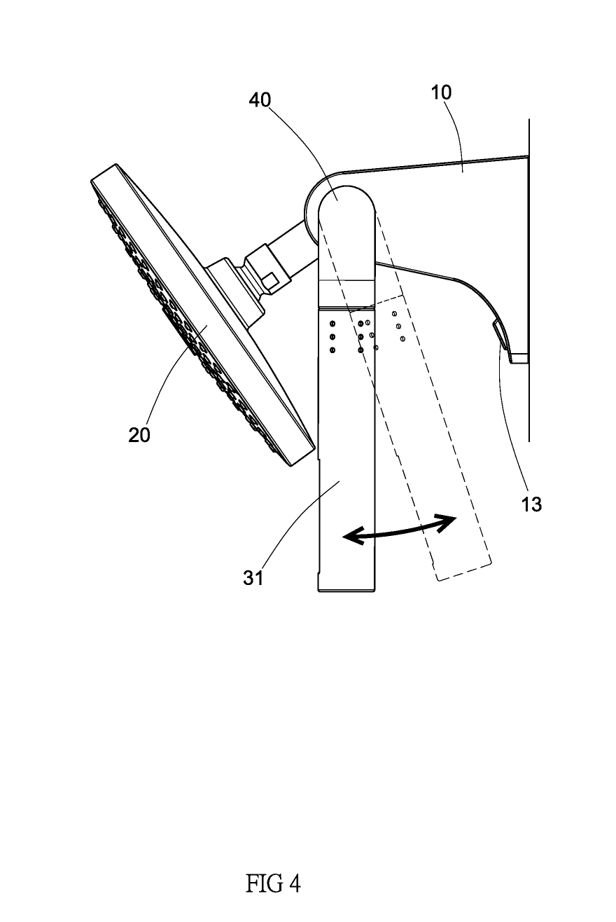

In FIG. 4, since the adapter elbow 40 of this disclosure is installed at the protrusion 14 of the fixed base 10, and the free end of the adapter elbow 40 is provided for fixing the pipe member 31, therefore the hot air structure 40 can be pivoted to an appropriate angle to allow the users to adjust the angle as needed. The operation is simple and convenient.

What is claimed is:

1. A shower structure with a hot air function, comprising:
a fixed seat, having a water supply end and a water outlet disposed at predetermined positions of the fixed base respectively, and a watertight switch installed at a predetermined position of the fixed base;
a shower head, with an end coupled to the water outlet of the fixed base;
a hot air structure, comprised of one or more pipe members, one or more fans and one or more electrical heating pipes, and a plurality of air inlet holes and an air outlet formed at predetermined positions of the external periphery of the pipe member respectively, and the fan and the electrical heating pipe being installed in the pipe member, and the fan and the electrical heating pipe being electrically coupled to the switch of the fixed base.

2. The shower structure with a hot air function according to claim 1, wherein the shower head is a top shower head.

3. The shower structure with a hot air function according to claim 1, wherein the shower head is a handheld shower head.

4. The shower structure with a hot air function according to claim 1, wherein the air outlet of the pipe member is in the shape of a cut groove.

5. The shower structure with a hot air function according to claim 1, further comprising an adapter elbow, a protrusion protruded from an outer side of the fixed base for fixing the adapter elbow, and a free end of the adapter elbow being provided for fixing the pipe member, so that the hot air structure can be pivoted to an appropriate angle.
